(19) United States
(12) Patent Application Publication
(10) Pub. No.: US 2003/0083915 A1
(43) Pub. Date: May 1, 2003

(54) Process development process methodology

(76) Inventors: Diego Guicciardi, Houston, TX (US); George P. Lucas, Missouri City, TX (US)

Correspondence Address: ROSENTHAL & OSHA L.L.P., 1221 MCKINNEY AVENUE, SUITE 2800, HOUSTON, TX, 77010, US

(21) Appl. No.: 10/281,560

(22) Filed: Oct. 28, 2002

Related U.S. Application Data
(60) Provisional application No. 60/346,077, filed on Oct. 29, 2001.

(51) Int. Cl. G06F 17/60

(52) U.S. Cl. 705/7

(57) ABSTRACT

A method of developing a process includes generating a prototype workflow of the process, evaluating the prototype workflow of the process, and generating a Process Development Process (PDP) workflow and populating a PDP toolkit using a result of the evaluation of the prototype workflow. A Process Development Process (PDP) template for developing a process includes a PDP workflow and a PDP toolkit for facilitating the generation of a workflow of the process during execution of the PDP workflow.

### CROSS-REFERENCE TO RELATED APPLICATIONS

This application claims benefit of U.S. Provisional Application No. 60/346,077, entitled “Process Design Methodology,” filed Oct. 29, 2001.

### BACKGROUND OF INVENTION

Technology solutions created by business and technical consultants often involve processes. A process is a set of business activities that transform a set of inputs into a set of outputs (inputs and outputs typically being goods or services). FIG. 1 shows entities associated with a process (10). Inputs (12) to the process (10) come from a first entity such as a supplier (14). Outputs (16) go to a second entity, such as a customer (18). A process is generally intended to accomplish some desired outcome or result, i.e., a goal, such as increasing sales.

For example, an organization may hire a VPN rollout team, which includes one or more technical consultants, to design and install a Virtual Private Network (VPN) in order to better serve its clientele. Typically, the organization already has in place a set of processes that help the organization accomplish its goals. For example, the organization may have processes to guide employees in everyday activities, such as an instruction sheet telling employees how to send a fax, or online help files telling employees how to arrange a videoconference, etc. In the course of designing and installing the VPN, the VPN rollout team may consider what changes need to be made to current processes in order to migrate the organization from whatever network systems are currently used, to the VPN. For example, the VPN rollout team may make modifications to existing processes (e.g., the VPN rollout team may include instructions for how to use the VPN in video conferencing situations). In the course of the VPN rollout, the VPN rollout team may also restructure the organization's organizational hierarchy in order to facilitate migration to the VPN.

Additionally, the VPN rollout team may be required to develop entirely new processes for the organization. Process development often uses certain well-known tools and analytical techniques, such as process development and modeling techniques and software, process workflow mappings, etc. A process workflow mapping describes sequential and/or concurrent workflow activities essential to a process. For example, a systems administrator for the organization may handle troubleshooting of network problems by following certain procedures. For example, the systems administrator may first check certain configuration files, then, secondly check for ping times, etc. Thus, such procedures form a process workflow.

The process workflow may be decomposed into multiple components, e.g., checking ping times. A particular component of the process workflow may be decomposed into subordinate components. For example, checking ping times may include a subordinate component of executing a particular shell script. The particular arrangement of the components of the process workflow (e.g., a particular chronological sequence of performing each component) is a process workflow. The components of the process workflow are executed by the employees, e.g., the system administrator checks configuration files and checks ping times.

Processes are often categorized as either procedural-based processes, or project-based processes. An example of a procedural-based process is the previous example of the trouble-shooting of network problems by the systems administrator. An example of a project-based process is the previous example of the VPN rollout.

Tools may be used to generate documentation related to process workflow, process modeling and development, etc. For example, a software package such as Teamflow™ (a trademark of CFM, Inc.) to map process workflows. Another tool for modeling processes is a process definition notation, such as Entry Task Validation Exit (EVTX) notation. EVTX is often used among process development teams in order to model processes. FIG. 2 shows an ETVX process cell (30) for process development. An entry criteria checklist (32), which is a list of criteria satisfied before starting a process proper, is performed. Then, a task list (34) is performed (e.g., check certain configuration files, then, secondly check for ping times, etc.), and a validation/verification procedure (36) is performed for quality control purposes. Finally, an exit criteria checklist (38) is performed.

When a team of technical consultants is hired by a client organization to develop one or more new processes, the team may often follow a routine method of developing a potential new process. FIG. 3 shows a flow diagram for process development, such as may be used by the VPN rollout team. The VPN rollout team first analyzes the goals, needs, and resources of the client organization with respect to the potential new process (Step 50). Collateral information may be collected as part of Step 50. Collateral information is information helpful for process development. For example, the VPN rollout team may determine which employees are responsible for which components of the new process. Next, a new process workflow is developed that fits the goals, needs, and resources of the client organization (Step 52). Once the new process workflow is developed, support is provided for execution of the new process workflow (Step 54). For example, the VPN team may supply documentation for training, such as help files, process performance assessment tools, location of relevant reference knowledge, etc. The collateral information may be used in order to provide such support and documentation. Support may be critical for project-based processes, especially processes developed for use in a collaborative environment, such as for a client organization that has employees that need to interact using communication networks.

Then, the new process workflow is executed (i.e., the components of the new process workflow are executed), and an evaluation is made of the performance of the new process workflow (Step 56). Performance evaluation may involve both quantitative and qualitative input. For example, network downtimes may be measured as a metric of evaluating the performance of the new process workflow. Also, evaluation may be in the form of opinions from Subject Matter Experts (SME's).

Then, the new process workflow is modified as needed, based on the evaluation (Step 58). For example, certain components of the process workflow may be modified in order to achieved desired outcomes and goals; such modifications are often guided by quantified metrics, lessons learned during execution of the process workflow, and best practices developed by employees involved in process workflow execution.

The VPN rollout team may develop multiple new processes for the client organization using the flow diagram shown in FIG. 3, and when work is complete, collect a fee, and move on to another client organization, once again performing the method shown in FIG. 3. Often, new processes are developed for different clients in a de novo fashion, i.e., new processes for each new client are developed “from scratch.”

### SUMMARY OF INVENTION

In general, in one aspect, a method of developing a process comprises generating a prototype workflow of the process; evaluating the prototype workflow of the process; and generating a Process Development Process (PDP) workflow and populating a PDP toolkit using a result of the evaluation of the prototype workflow.

In general, in one aspect, a method of developing a process, comprises generating a prototype workflow of the process; evaluating the prototype workflow of the process; generating a Process Development Process (PDP) workflow and populating a PDP toolkit using a result of the evaluation of the prototype workflow; and generating a workflow of the process by a user executing the PDP workflow using the PDP toolkit.

In general, in one aspect, a Process Development Process (PDP) template for developing a process comprises a PDP workflow; and a PDP toolkit for facilitating the generation of a workflow of the process during execution of the PDP workflow.

In general, in one aspect, an apparatus for developing a process, comprises a means for generating a prototype workflow of the process; a means for evaluating the prototype workflow of the process; and a means for generating a Process Development Process (PDP) workflow and populating a PDP toolkit using a result of the evaluation of the prototype workflow.

In general, in one aspect, an apparatus for developing a process comprises a means for generating a prototype workflow of the process; a means for evaluating the prototype workflow of the process; a means for generating a Process Development Process (PDP) workflow and populating a PDP toolkit using a result of the evaluation of the prototype workflow; and a means for generating a workflow of the process by a user executing the PDP workflow using the PDP toolkit.

Other aspects and advantages of the invention will be apparent from the following description and the appended claims.

### BRIEF DESCRIPTION OF DRAWINGS

FIG. 1 shows entities associated with a process.

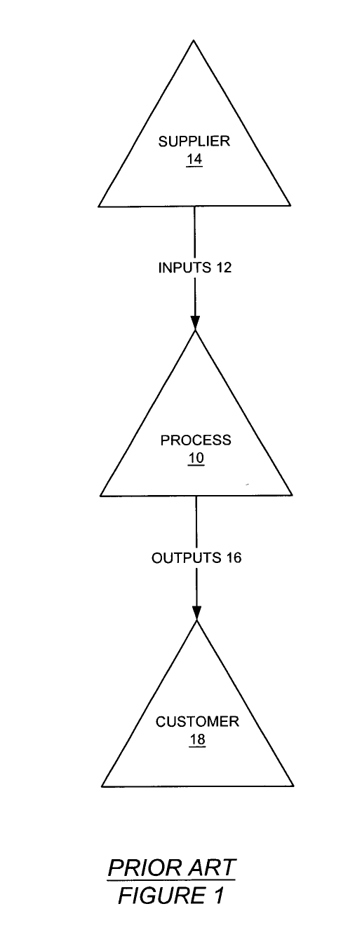

FIG. 2 shows an Entry Test Validation Exit (ETVX) process cell used for process development.

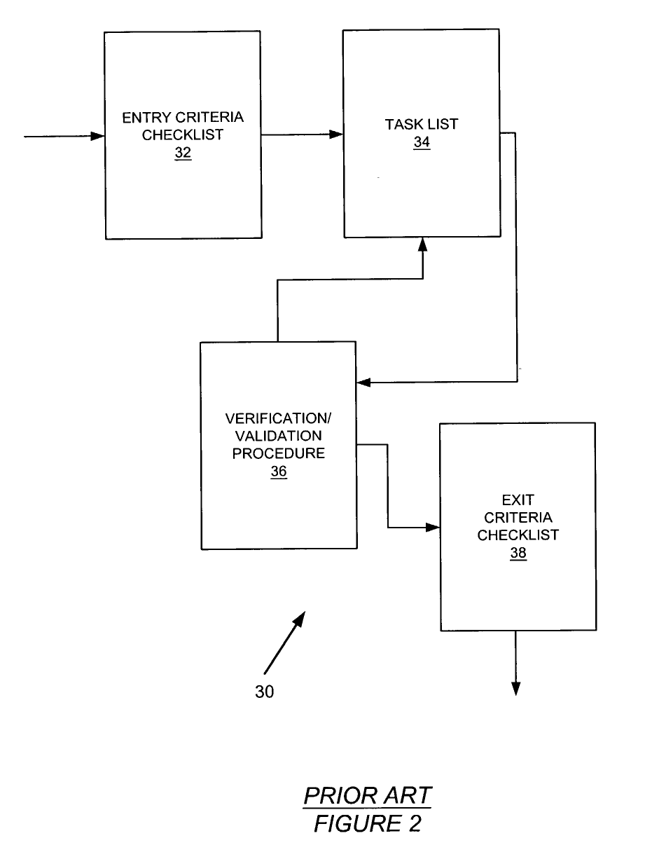

FIG. 3 shows a flow diagram for process development.

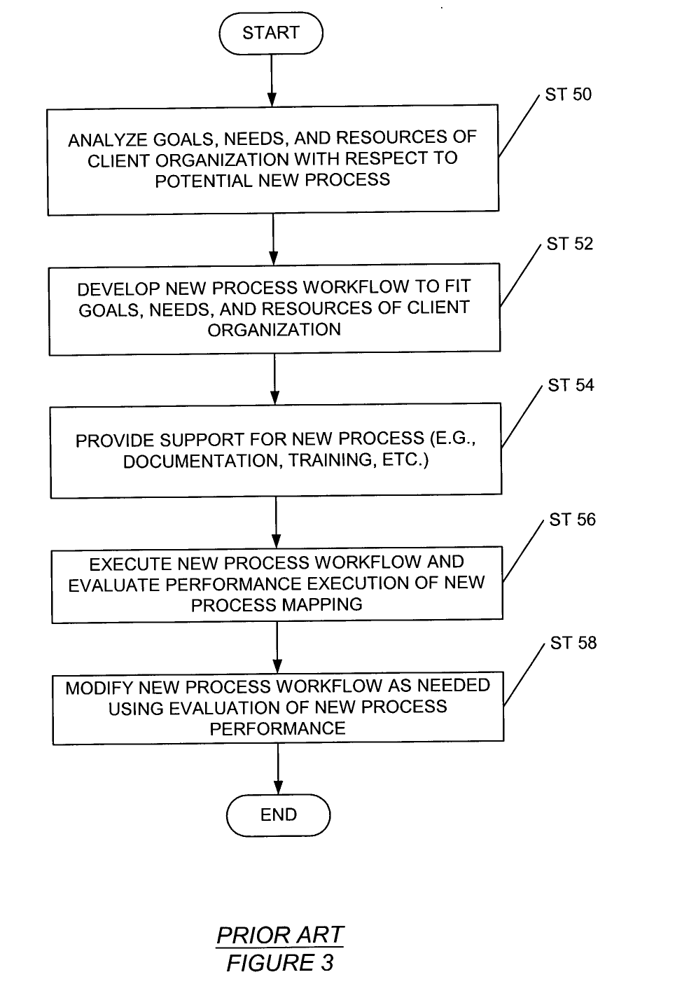

FIG. 4 shows an exemplary networked computer system.

FIG. 5 shows a flow diagram of a Process Development Process (PDP) methodology for developing a process in accordance with an embodiment of the invention.

FIG. 6 shows a Graphical User Interface (GUI) representing a flow diagram showing top-level components of a PDP workflow in accordance with an embodiment of the invention.

FIG. 7 shows a GUI with icons representing multiple PDP workflow components in accordance with an embodiment of the invention.

FIG. 8 shows an exemplary Process Configuration Form in accordance with an embodiment of the invention.

FIG. 9 shows a GUI showing icons representing lower-level PDP workflow components in accordance with an embodiment of the invention.

FIG. 10 shows a PDP template in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

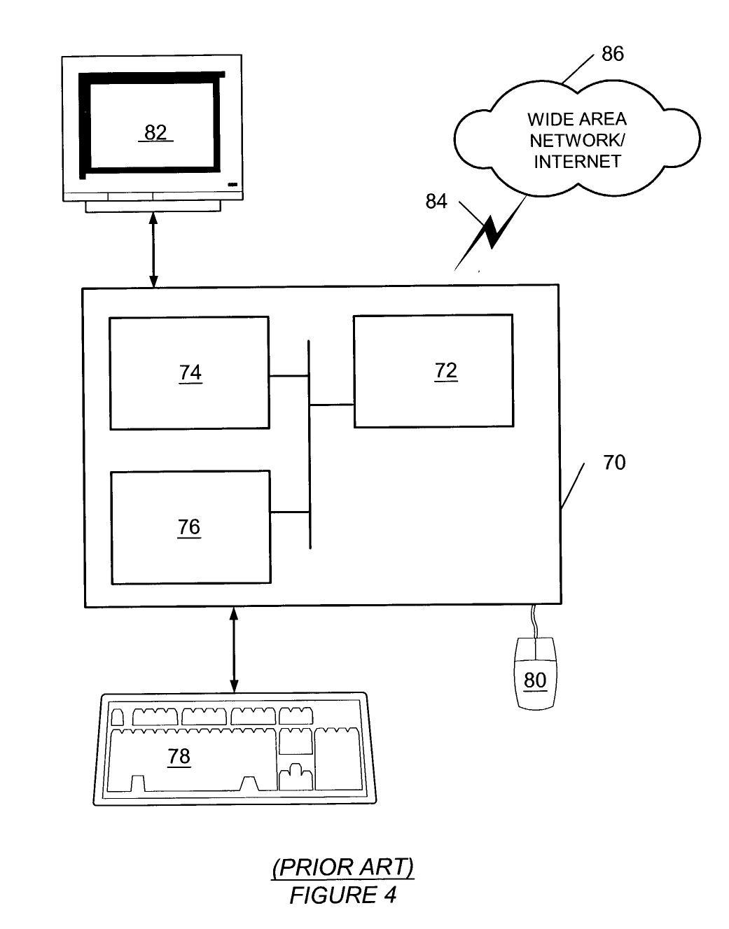

Certain aspects of the invention may be implemented on virtually any type computer regardless of the platform being used. For example, as shown in FIG. 4, a typical computer (70) includes a processor (72), an associated memory (74), a storage device (76), and numerous other elements and functionalities typical of today's computers (not shown). The computer (70) may also include input means, such as a keyboard (78) and a mouse (80), and an output device, such as a monitor (82). Those skilled in the art will appreciate that these input and output means may take other forms in an accessible environment. The computer (70) may be connected via a network connection (84) to a Wide Area Network (WAN) (86), such as the Internet.

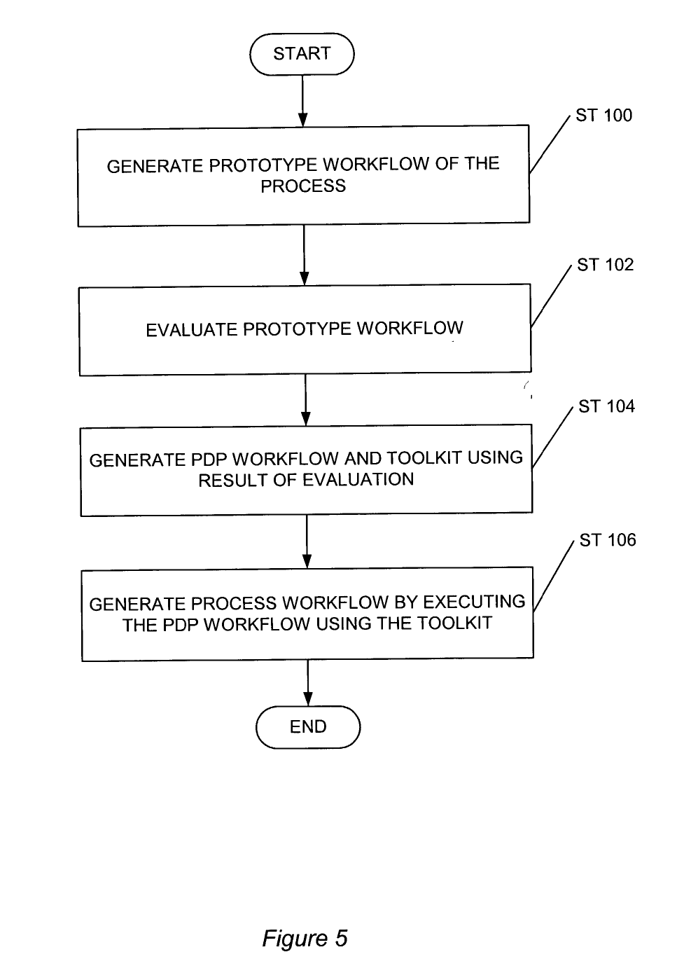

The invention, in one or more aspects, involves developing processes in a manner intended to address issues of quality and efficiency, and provides a solid structural framework for development of a process. A flow diagram of a Process Development Process (PDP) methodology for developing a process is shown in FIG. 5. First, a prototype workflow of the process is generated (Step 100). The prototype workflow may entail, in accordance with one or more embodiments of the invention, developing the process “from scratch.” The process may be a project-based process, such as a process for rolling out a VPN, or a procedural-based process, such as a process for troubleshooting a network.

Once the prototype workflow is generated, the prototype workflow is evaluated (Step 102). Evaluating the prototype workflow includes determining what actions are required in order to generate the prototype workflow, and what collateral information is pertinent. Evaluating the prototype workflow may also include executing the prototype workflow in order to evaluate performance and effectiveness of the prototype workflow. Metrics information may also be obtained in order to evaluate the prototype workflow. For example, one or more pertinent parameters may be measured in order to evaluate performance of the prototype workflow. For example, if the process deals with networks, then network downtime may be measured.

Collateral information includes any information deemed useful in developing the prototype workflow and enhancing performance and quality of the prototype workflow. Collateral information may be information shown to be useful in light of experience. For example, after executing and evaluating the prototype workflow, a particular lesson learned may be used to form a best practice for future execution.

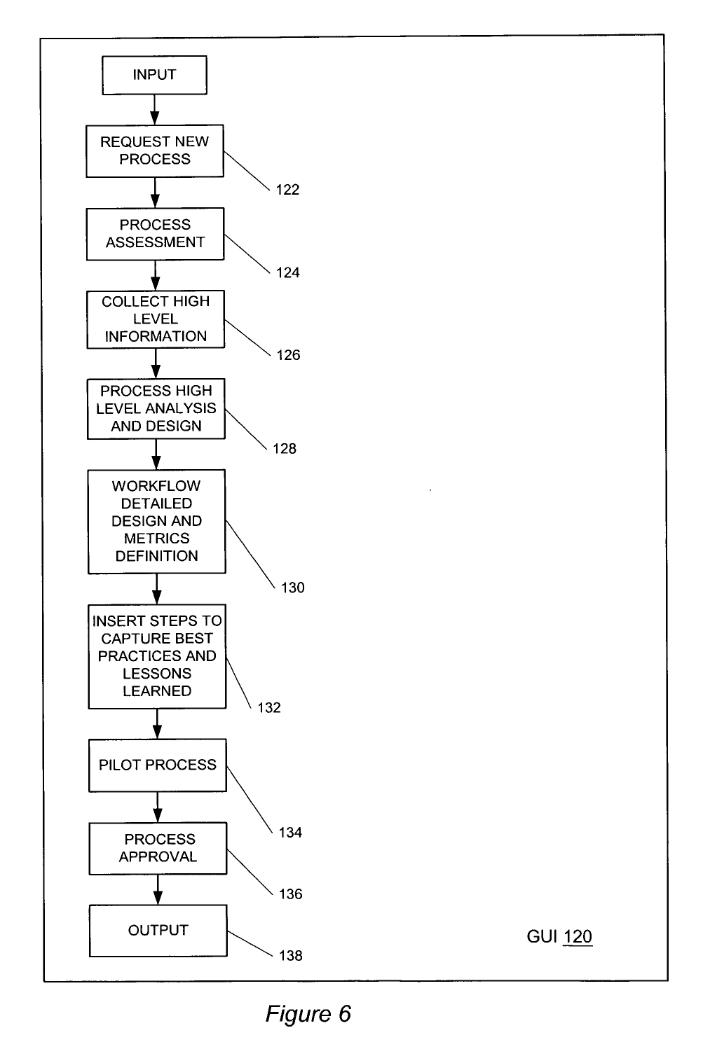

Once the prototype workflow has been evaluated, a PDP workflow and PDP toolkit are generated using a result of the evaluation (Step 104). The PDP workflow is a top-down methodology for guiding a user or multiple users through development of a process workflow. The PDP toolkit includes, among other items, a graphical representation of components of the PDP workflow. FIG. 6 shows a GUI (120) representing a flow diagram that shows top-level components of the PDP workflow. The top-level components of the PDP workflow are modeling using Teamflow™. However, those skilled in the art will appreciate that other similar modeling tools may be used.

A first component of the PDP workflow involves requesting a new process (Step 122). For example, a client may require that a new process be developed in order to facilitate a VPN rollout. Often, development of new processes, in accordance with one or more embodiments of the invention, occurs as part of a process development project. Such a process development project may be implemented, in accordance with one or more embodiments of the invention, in a networked, collaborative workspace that involves multiple project members working together using collaboration software, such as Project.Net™.

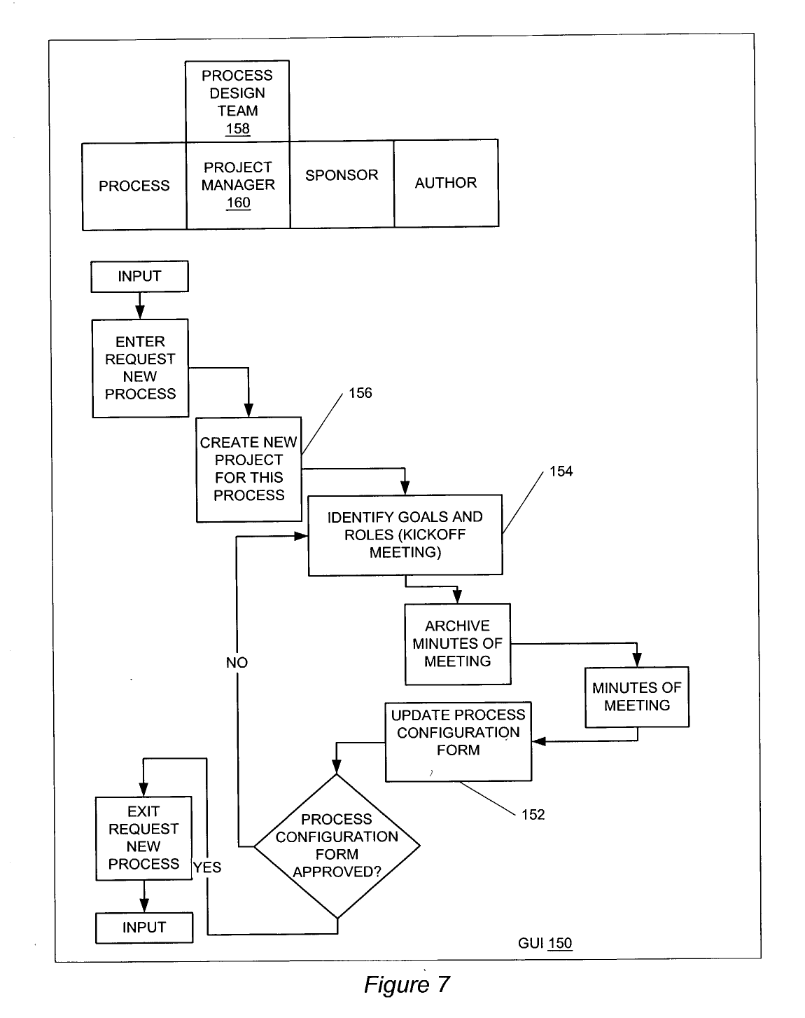

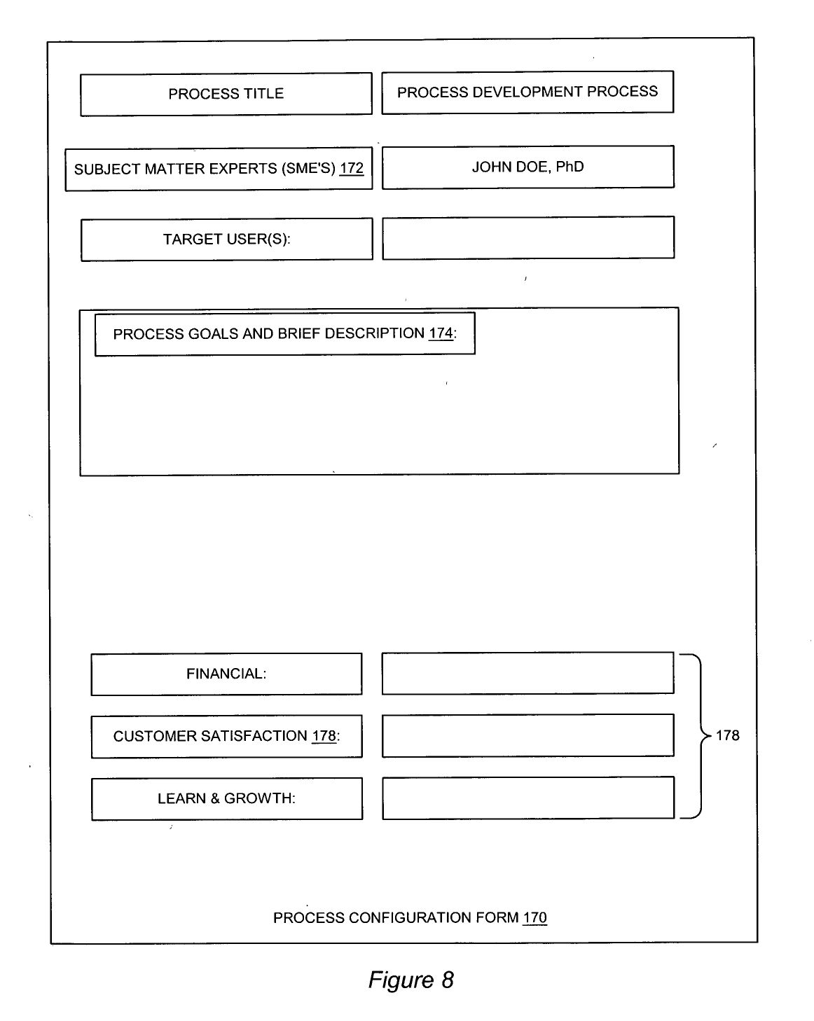

The first component of the PDP workflow, represented by an icon labeled “Request new process” (Step 122) is a top-level representation of multiple workflow components, each of which exist at lower hierarchy levels, and which are, in turn, shown on other GUI's that represent flow diagrams representing subordinate, lower-level PDP workflow components. For example, FIG. 7 shows a GUI (150) with icons representing multiple PDP workflow components, which may represent suggested tasks, such as “Update Process Configuration Form” (152). FIG. 8 shows an exemplary Process Configuration Form (170). The Process Configuration Form (170) is included as part of the PDP toolkit, and is used to organize and present information vital to development of the process, such as SME's involved in development of the process (172), a listing of goals and a description of the process being developed (174), a grouping of metrics parameters (176), such as customer satisfaction (178). Information associated with the Process Configuration Form (170) is typically both static and dynamic in nature, and describes characteristics of the process workflow in development. Parts of the Process Configuration Form (170) are updated regularly during development of the process, and as such, the Process Configuration Form (170) may be used to record and monitor completion status of process development.

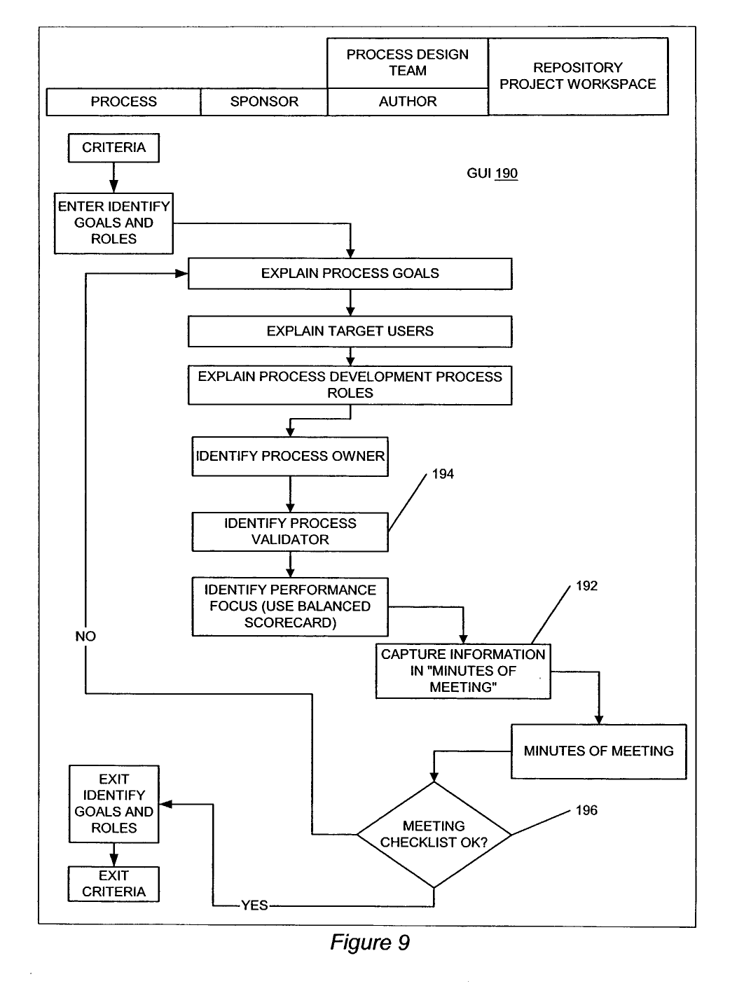

Returning to FIG. 7, an icon labeled “Identify Goals & Roles (Kickoff meeting)” (154) represents a PDP workflow component, which represents multiple lower-level workflow components, which are shown in FIG. 9, which shows a GUI (190) that shows icons representing lower-level PDP workflow components, such as an icon labeled “Capture information in the ‘Minutes of Meeting’” (192). Information captured in meeting minutes may be included in collateral information, which is used to provide documentation to support execution of the process by the client organization. Other workflow components may suggest tasks to be performed, such as assigning roles and responsibilities for people involved in developing, supporting, and executing the process, such as represented by an icon labeled “Identify Process Validator” (194). An example of task verification, as embodied by ETVX principles, is represented by an icon labeled “Meeting Checklist OK?” (196).

Returning to FIG. 7, graphical linkage of roles and responsibilities for people involved in development of the process is shown by positional location of icons that represent PDP workflow components shown on the GUI (150). For example, an icon labeled “Create a new project for this process” (156) is the responsibility of a process design team and a project manager, as represented by icons labeled “Process Design Team” (158) and “Project Manager” (160), respectively.

Returning to FIG. 6, once the process is requested, the requested process is assessed (Step 124). Similar to the new process request PDP workflow component shown in Step 122, the process assessment PDP workflow component (Step 124) also represents multiple lower-level PDP workflow components, which are also represented by icons, which may be shown on GUI's implemented in Teamflow™. Although the lower-level PDP workflow components are not shown herein, lower-level PDP workflow components represented by Step 124 (and each other step shown in FIG. 7), like Step 122, also model the PDP workflow, suggest tasks, verify tasks, collect collateral information in both quantitative and qualitative forms. For example, the user may be presented with a questionnaire using a GUI (included as part of the PDP toolkit) that includes questions relating to desired goals of the process.

After process assessment, high level information associated with the requested process is collected (Step 126). Lower-level PDP workflow components for Step 126, although not shown herein, are represented by GUI icons. The high level information relates to gathering collateral information regarding roles and responsibilities of people involved in developing, supporting, and executing the process. High-level information may also include location of possible collateral knowledge, such as relevant reference knowledge, such as previously developed processes that may be recycled. Collateral information related to needed personnel training is also collected, which may be included in documentation for training to support execution of the process.

Next, process high level analysis and design associated with the process is performed (Step 128). Lower-level PDP workflow components for Step 128, although not shown herein, are represented by GUI icons. Process high level analysis and design involves decomposing components of the process into subordinate components. The PDP workflow may be divided into parallel phases, which are implemented concurrently as sub-processes. Roles and responsibilities are also assigned appropriately. For example, SME's will be assigned to particular components of a phase. Sources of relevant information are also identified. Also, task verification for particular PDP workflow components is accomplished.

Once process high level analysis and design is accomplished, then, workflow detailed design and metrics definition associated with the requested process is performed (Step 130). Lower-level PDP workflow components for Step 130, although not shown herein, are represented by GUI icons. Workflow detailed design involves preparing a draft workflow for components and subordinate components, discussing and clarifying goals, further identifying roles and responsibilities, and locating relevant reference knowledge.

Workflows are also validated in Step 130. Validation of workflows may be implemented using ETVX modeling and applied standards. For example, assigned roles and sequencing of workflows is checked. Also accomplished in Step 130 is identification of metrics information sources for workflows. Information identified as sources of metrics information includes information that measures whether the process has been successfully executed and/or achieves particular goals.

Once workflow detailed design and metrics definition is accomplished, steps are inserted into the process workflow in order to capture best practices and lessons learned during execution of the process workflow (once the process workflow has been generated and executed) (Step 132). For example, a relevant knowledge source captured through a questionnaire may reveal that before a particular workflow component of the process is executed, backup copies of computer data should be made.

Once steps are inserted to capture best practices and lessons learned, potential pilot processes or sub-processes are identified and implemented (Step 134). For example, the process under development may include multiple subprocesses, one or more of which are more likely to be successfully implemented than other sub-processes, thus being likely candidates for pilot processes. Identifying a potential pilot process may be accomplished through analysis of information gathered from people such as SME's using parts of the PDP toolkit, such as interactive GUI'S.

A final top-level component of the PDP workflow is process approval (Step 136). Lower-level PDP workflow components for Step 136, although not shown herein, are represented by GUI icons. Step 136 involves validation each workflow component of the process under development for adherence to established standards. If a particular component of the process is not validated, the component is fixed.

An output of the PDP (138) includes a process workflow, e.g., a process for rolling out a VPN, or for troubleshooting a network. The output of the PDP (38) also includes the collateral knowledge, as gathered using PDP toolkit mechanisms, such as GUI questionnaires, etc., which is used to generate parts of the PDP toolkit. The PDP toolkit includes a graphical representation of the PDP workflow, portions of which were shown in FIGS. 6-9, and which is used to guide users in executing the PDP workflow, and thereby generating the workflow of the process, which the client requires (e.g., the process to rollout a VPN, or the process to troubleshoot a network, etc.). The PDP toolkit also includes other documentation, such as assessment tools, such as GUI questionnaires, work files, help files, training documents, graphical aides, such as pictures, plans for initiating process development projects, blank engagement letters and other standard business documents, and ancillary documents as needed.

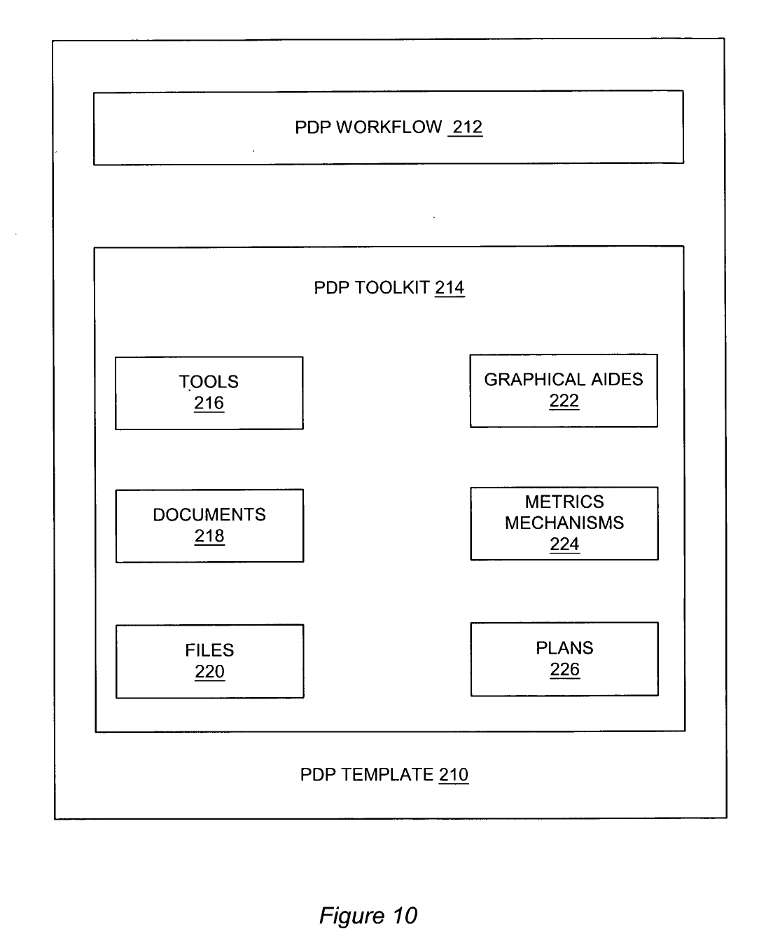

Thus, the PDP workflow and the PDP toolkit provide a template, a PDP template, for developing processes. FIG. 10 shows the PDP template (210), which includes the PDP workflow (212), and the PDP toolkit (214). The PDP toolkit (214) includes items (such as those named above), and represented generically as tools (216) (such as the GUI's shown in FIGS. 6-9 and used to guide users), documents (218), files (220), graphical aides (222), metrics mechanisms (224), and plans (226).

Returning to FIG. 5, the process workflow is generated by one or more users (typically a project team operating in a collaborative environment) executing the PDP workflow by using the PDP toolkit (Step 106). The PDP toolkit guides the users in the execution of the PDP workflow, thus creating the process workflow, which the client may use to rollout a VPN, troubleshoot a network, etc. The PDP toolkit and PDP workflow also provide mechanisms for modifying the workflow to create an improved workflow via mechanisms to capture lessons learned and best practices.

Advantages of various embodiments of the present invention may include one or more of the following. In one or more embodiments, the present invention is an efficient and effective tool for avoiding the duplication of effort that often accompanies de novo process development, consistently producing quality work product, and evolving one process or project into future processes or projects. When new processes are created, a structured design methodology clearly documents the process, models workflow, suggests and verifies tasks, and provides a consistent and recognizable notation. Organizational structure, roles, and responsibilities are integral to the process definition.

The quality, consistency, correctness, appropriateness, and completeness of a process, and/or the documentation of that process, are properly captured and that knowledge is well managed. Best practices are captured and directly linked to associated processes. Metrics on process performance and efficacy are coupled to the projects they evaluate and are evenly and strategically applied. Process evolution (lifecycle, versioning, efficacy) is effectively managed. Process development is treated as a collaborative project. There is a uniform method to migrate a process into a project template, and to extract best practices and lessons learned from a project to evolve the related process. Further, consistent instantiation of processes into projects results in even project execution that follows good process flow.

The present invention is widely applicable. For instance, embodiments may be used by project-oriented organizations that require improved processes and/or more effective collaboration in the conduct of their projects or any organization with a need to repetitively perform projects in a more efficient and consistent way. Examples may include the upstream operations of energy and energy services companies, the engineering and construction industry, consulting, and other service organizations involved in project-oriented business.

Further, the present invention can also be applied to process development for more procedurally-oriented businesses. Procedural processes appear in all organizations, but are particularly important in service provider, healthcare, insurance, and financial organizations, and in most information processing businesses. In these markets, the disclosed methodology will produce processes closely aligned with a customer's procedural needs. Those skilled in the art will appreciate that there are other areas to which embodiments of the present invention apply as well.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of developing a process comprising:
generating a prototype workflow of the process;
evaluating the prototype workflow of the process; and
generating a Process Development Process (PDP) workflow and populating a PDP toolkit using a result of the evaluation of the prototype workflow.

2. The method of claim 1, further comprising:
generating a workflow of the process by a user executing the PDP workflow using the PDP toolkit.

3. The method of claim 2, wherein the PDP workflow comprises an instruction for the user for the generation of the workflow of the process.

4. The method of claim 2, wherein the PDP workflow comprises a mechanism for obtaining collateral information from the user.

5. The method of claim 4, wherein the collateral information comprises a desired outcome of executing the workflow of the process.

6. The method of claim 4, wherein the collateral information comprises a role of a person with respect to executing the workflow of the process.

7. The method of claim 4, wherein the collateral information comprises a role of a person with respect to generating the workflow of the process.

8. The method of claim 4, wherein the collateral information comprises a completion status of a component of the PDP workflow.

9. The method of claim 1, wherein the PDP toolkit comprises a graphical aid to facilitate a top-down decomposition of the PDP workflow for a user.

10. The method of claim 2, wherein the PDP toolkit comprises a graphical aid to facilitate an execution of the PDP workflow.

11. The method of claim 2, wherein the PDP toolkit comprises a descriptive characteristic of the workflow of the process.

12. The method of claim 2, wherein the PDP toolkit comprises a quantitative metrics mechanism for obtaining a quantified result of executing the workflow of the process.

13. The method of claim 12, wherein the quantified result is used to modify the workflow of the process.

14. The method of claim 2, wherein the PDP toolkit comprises a qualitative metrics mechanism for obtaining a qualitative result of executing the workflow of the process.

15. The method of claim 14, wherein the qualitative result is used to modify the workflow of the process.

16. The method of claim 1, wherein the PDP workflow comprises a mechanism for suggesting tasks to the user.

17. The method of claim 1, wherein the PDP workflow comprises a mechanism for verifying a component of the PDP workflow.

18. The method of claim 1, wherein the PDP workflow comprises a mechanism for recycling knowledge.

19. The method of claim 1, wherein the PDP toolkit comprises a mechanism for recycling knowledge.

20. The method of claim 1, wherein the PDP workflow comprises a mechanism for identifying resources.

21. The method of claim 2, wherein the PDP toolkit comprises documentation supporting execution of the workflow of the process.

22. The method of claim 1, wherein the Process Development Process (PDP) workflow comprises:
obtaining a request for a new process;
assessing the requested process;
collect high level information related to the requested process;
performing a high level analysis and design of the requested process;
performing a detailed design and metrics definition for the requested process;
inserting steps into the workflow of the process for capturing best practices and lessons learned from the execution of the workflow of the process;
identifying a potential pilot sub-process of the process; and
approving the workflow of the process.

23. A method of developing a process comprising:
generating a prototype workflow of the process;
evaluating the prototype workflow of the process;
generating a Process Development Process (PDP) workflow and populating a PDP toolkit using a result of the evaluation of the prototype workflow; and
generating a workflow of the process by a user executing the PDP workflow using the PDP toolkit.

24. A Process Development Process (PDP) template for developing a process comprising:
a PDP workflow; and
a PDP toolkit for facilitating the generation of a workflow of the process during execution of the PDP workflow.

25. The PDP template of claim 24, wherein the PDP workflow is generated using a result of an evaluation of a prototype workflow of the process.

26. The PDP template of claim 24, wherein the PDP toolkit is generated using a result of an evaluation of a prototype workflow of the process.

27. The PDP template of claim 24, wherein the PDP toolkit is configured to obtain collateral information from the user.

28. The PDP template of claim 27, wherein the collateral information comprises a desired outcome of executing the workflow of the process.

29. The PDP template of claim 27, wherein the collateral information comprises a role of a person with respect to executing the workflow of the process.

30. The PDP template of claim 27, wherein the collateral information comprises a status of a component of the PDP workflow.

31. The PDP template of claim 24, wherein the PDP toolkit comprises a graphical aid to facilitate a top-down decomposition of the PDP workflow for a user.

32. The PDP template of claim 31, wherein the top-down decomposition comprises a PDP component hierarchy.

33. The PDP template of claim 24, wherein the PDP toolkit comprises a graphical aid to facilitate the execution of the PDP workflow.

34. The PDP template of claim 24, wherein the PDP toolkit comprises a characteristic of the workflow of the process.

35. The PDP template of claim 24, wherein the PDP toolkit comprises a quantitative metrics mechanism for obtaining a quantified result of executing the workflow of the process.

36. The PDP template of claim 35, wherein the quantified result is used to modify the workflow of the process.

37. The PDP template of claim 24, wherein the PDP toolkit comprises a qualitative metrics mechanism for obtaining a qualitative result of executing the workflow of the process.

38. The PDP template of claim 37, wherein the qualitative result is used to modify the workflow of the process.

39. The PDP template of claim 24, wherein the PDP toolkit comprises ancillary documentation.

40. An apparatus for developing a process comprising:
a means for generating a prototype workflow of the process;
a means for evaluating the prototype workflow of the process; and
a means for generating a Process Development Process (PDP) workflow and populating a PDP toolkit using a result of the evaluation of the prototype workflow.

41. The apparatus of claim 40, further comprising:
a means for generating a workflow of the process by a user executing the PDP workflow using the PDP toolkit.

42. An apparatus for developing a process comprising:
a means for generating a prototype workflow of the process;
a means for evaluating the prototype workflow of the process;
a means for generating a Process Development Process (PDP) workflow and populating a PDP toolkit using a result of the evaluation of the prototype workflow; and
a means for generating a workflow of the process by a user executing the PDP workflow using the PDP toolkit.
